(19) United States
(12) Patent Application Publication
(10) Pub. No.: US 2003/0065543 A1
(43) Pub. Date: Apr. 3, 2003

(54) Expert systems and methods

(76) Inventor: Arthur Allan Anderson, West Shokan, NY (US)

Correspondence Address: WHITE & CASE LLP, PATENT DEPARTMENT, 1155 AVENUE OF THE AMERICAS, NEW YORK, NY, 10036, US

(21) Appl. No.: 10/260,857

(22) Filed: Sep. 27, 2002

Related U.S. Application Data
(60) Provisional application No. 60/326,066, filed on Sep. 28, 2001.

(51) Int. Cl. G06F 17/60

(52) U.S. Cl. 705/7

(57) ABSTRACT

The invention provides systems and methods for evaluating the productivity and efficiency of a business services provider, with respect to services provided to a particular user of said services, using quantitative benchmark data and qualitative best-practice/best-in-class data for similar services provided by similar service providers. Quantitative and qualitative data relating to the business service provider being evaluated is conformed a categorical framework so that it can be readily compared to similarly conformed quantitative benchmark data and qualitative data. The methods and systems for the invention generate evaluation/assessment reports showing the degree to which the service provider's business metrics deviate from the benchmarks and how the practices and structure of the service provider differ from best-practice/best-in-class designations. The invention further provides methods and systems for the periodic and/or continuing evaluation of the service provider.

This application claims priority to U.S. provisional application serial No. 60/326,066, filed Sep. 28, 2001, which is hereby incorporated by reference in its entirety.

### FIELD OF THE INVENTION

This invention relates in general to the field of productivity and financial analysis, and more particularly to systems and methods for generating business services provider productivity and remuneration-correctness assessments.

### BACKGROUND

Many managers and consultants wish to assess business services provider productivity and efficiency with respect to other business services providers or the entire provider community for a given service area. It is often desirable to assess business services provider productivity and remuneration-correctness by comparing data associated with business services providers from one business services organization and community to data associated with business services from like or different organizations. For example, a series of comparisons might be performed to assess business services productivity and economics within an organization relative to other organizations, relative to related organizations or relative to communities of different business services providers, in accordance with various financial and productivity metrics.

As business services providers and their users become larger and more complex, managers and consultants may wish to assess business services provider remuneration and productivity using various economic and resource assessment methodologies. A known technique for assessing resource economics and productivity measures remuneration techniques such as hourly rates, fees, and commission rates. Although this approach has been historically used, particularly in user environments where a user's resource needs and spending are constant or where business provider economics are constant or driven by user spending, such an approach is of limited value in situations where the business environment is complex, has many variables, where efficiency and effectiveness need to be maximized, and/or where the services of the business services provider is activity-driven or involves cost containment and adding value to the business services user.

In newer and more complex environments, it is important for the user, i.e., consumer, of business services to have a more transparent understanding of the business services provider staffing and economics in order to be able to relate the provider's specific services with the most appropriate worker staffing plan and provider economics.

U.S. Pat. No. 5,262,941 discloses computer-implemented systems and methods for generating a floorplan credit recommendation. U.S. Pat. No. 5,909,669 discloses a computer-implemented system and method for generating a knowledge worker productivity assessment. U.S. Pat. No. 6,430,536 B2 discloses a computer-implemented system and method for managing the utilization of medical imaging equipment of a health care organization and generating reports related thereto. Each of U.S. Pat. No. 5,262,941, U.S. Pat. No. 5,909,669 and U.S. Pat. No. 6,430,536 B2 is hereby incorporated by reference in its entirety. Reviews of the state of art of compensation analysis for advertising agency service are provided by Ahlgren, H. Ed, Agency Compensation: A Guidebook, New York Assoc. of Advertisers (1979); Patterns of Agency Compensation, American Assoc. of Advertising Agencies (1980); Guidelines for Effective Advertiser/Agency Remuneration, Assoc. of Canadian Advertisers (1995); and Jones, C. B. and Lundin L. Agency Compensation: A Guidebook, Assoc. of National Advertisers (1995), each of which is hereby incorporated by reference in its entirety.

### SUMMARY OF THE INVENTION

The present invention addresses the previously outstanding problems and limitations associated with evaluating business services provider productivity and remuneration-correctness, while at the same time providing recommendations for optimizing the business provider's productivity/efficiency as it relates to the remuneration provided by the user/customer/client, time and/or other criteria.

Accordingly, the invention provides systems and methods of evaluation that are applicable to and effective with nearly any business services areas. Examples of business services areas for which the invention is useful include, but are not limited to, advertising and other marketing communications services, legal services, consulting services, accounting services, financial services engineering services, architectural services and other design services and information and other technology services.

Advantageously, the invention also provides computer implemented methods and systems of the invention can evaluate a business service provider according to categorized benchmark, best practice and best-in-class knowledge obtained from one or more experts knowledgeable in the field(s) in which the resource operates.

The invention provides a computer-implemented method for evaluating the business metrics of a service provider in a predetermined service area, which comprise the steps of: providing quantitative benchmark business metric data for the service area, wherein the data is categorized by predetermined quantitative criteria in computer-readable memory; providing quantitative business metric data for the service provider to be evaluated wherein the data is categorized by preselected criteria in computer-readable memory; for at least one of the preselected criteria, generating a comparison value between the benchmark business metric data and the service provider business metric data; and generating a business metric evaluation report/assessment according to the comparison.

The invention further provides that this method may further comprise the steps of: providing, in computer-readable memory, qualitative best practice or best-in-class assignment information for the service area, wherein the best practice or best-in-class assignment data is categorized by predetermined qualitative criteria; providing, in computer-readable memory, qualitative information for the service provider categorized according to the predetermined qualitative criteria; and for at least one of the predetermined qualitative criteria, comparing the best practice or best-in-class assignment to the information for the service provider to determine for that criterion whether the productivity, economics and other business metric data of the service provider provides value to the user for the remuneration paid by the user to the service provider.

The invention still further provides that this method may further comprise the step of relating the qualitative criteria differences between best practice or best-in-class and service provider qualitative information to differences in the quantitative benchmark business metric data and service provider business metric data.

The invention further provides computer implemented systems for performing the various aspects of the methods of the invention.

### BRIEF DESCRIPTION OF THE DRAWINGS

FIG. 1 is a flowchart illustrating the quantitative and qualitative data assessment process according to one embodiment of the invention.

FIG. 2 illustrates an Internet-configured system according to the invention.

### DETAILED DESCRIPTION OF THE INVENTION

The present invention provides a system and method for generating a business services provider productivity and economic metrics assessment, as well as quantitative assessments concerning a business services provider and selected metrics of the environment surrounding the business services provider and a user of business services. The system generates comparison values using one or more metrics and compares the comparison values with one or more benchmark values obtained from knowledgeable experts and/or representing survey information of identical, related or different communities of business service providers and users. According to the invention, the may system generate one or more assessments concerning the targeted business services provider.

Using these productivity and remuneration-correctness assessments, managers and consultants can recommend modifications and enhancements to the processes of, and environment surrounding, business services providers so as to increase their productivity and the value-for-money, i.e., cost-effectiveness, of the services they provide to their customers. Assessments may be broad or may, for example, be limited to selected staffing resources of a business services provider or groups of business services providers within an organization. The assessment process may, for example, also be configured to extend to the goods and service providers of the business service provider which is the primary target of the evaluation. The assessment process according to the invention may be scalable to include the entire business services provider communities outside a targeted organization or community. Thus according to the invention, the assessment process may be configured to take any preselected extent and/or parts of the “supply chain” of the business services provider being evaluated.

Construction of the expert system begins with the development of a questionnaire and an expert diagnostic interview process for use with the business service resource. Senior members of the user's and the resource's management team or other knowledgeable persons as it may be, are be asked to provide substantive input to the expert questionnaire and to the expert diagnostic interview process.

Once the knowledgeable expert develops a questionnaire and a diagnostic interview script, quantitative data and qualitative information are collected from the business service resource. Qualitative information may be conveniently obtained primarily through diagnostic interviews. Quantitative data may conveniently be obtained through the questionnaire. However, the invention is not limited by the way in which the queries for data and information and the replies thereto are communicated. The collection of quantitative data and qualitative information may, for example, occur at the same time.

The diagnostic interviews and the questionnaires can be implemented in parallel or at separate times. Alternatively, for example, a single, integrated query and reporting format can be implemented, for example via the World Wide Web, in any suitable media format as known in the art.

Advantageously, in one embodiment of the invention, the diagnostic questionnaire and/or interview is administered via the World Wide Web by serving interactive web pages to designated authorized persons. Such communications can employ any of the standard security techniques known in the art to ensure that only authorized individuals may access the s system.

In one embodiment of the invention, until the comprehensive assessment stage, the expert system generally performs two separate procedures. The first involves the administration of the questionnaire and the collection and analysis of quantitative data regarding resource staffing and economics. The second involves diagnostic interviews and the collection and analysis of qualitative information regarding resource staffing and economics, the resource/user relationship, resource quality and work product, and related matters. At the comprehensive assessment stage, the expert system reduces to one mode aimed at enabling a user to originate, evaluate, manage, and monitor its business service resource relationships and compensation.

Expert Diagnostic Interviews: Collection and Analysis of Qualitative Information

Diagnostic interviews are intended to identify and assess various structures and resources that impact the efficiency and effectiveness of the resource and the user/resource business relationship. Another aspect of the diagnostic interview process is to ascertain quantitative metrics regarding the resource's scope of work and its staffing on the user's business and to ascertain the resource's performance on the user's account as well as relate this to resource compensation. Diagnostic interviews can, for example, be held in-person, by telephone, by survey, or by email or via the Internet, for example, on the world wide web. The interview, including surveys, can also be mounted by an knowledgeable expert or interviewer. After qualitative information (e.g., resource organizational structure and development), is collected, it is assessed as to the “best practices.” The qualitative data and other information is compared to “best practices” of comparable companies who are considered by peer companies and experts to be “best in class.” Variances between resource reported qualitative information and “best practice” information obtained from expert models and case histories are considered at the comprehensive assessment phase.

Expert Questionnaire: Collection and Analysis of Quantitative Data

The expert questionnaire is specially designed for each assessment as there are many variables, often differing, that make up a client's designed use of a resource and that impact the attendant user/resource business relationship. Major elements addressed in the questionnaire include the resource's scope of work (the activity on behalf of user), staffing (resource) plan for the user's account (e.g., nature/level of seniority of person(s) working on account/sub-accounts, staffing ratios of job positions working on account/sub-accounts [e.g., number of managers to number of designers]), and resource economics (e.g., salaries, overhead and profit/loss) for the user's account. The time series for each questionnaire is usually multiple years in order to identify year-to-year variances, but it can be used over any period of time.

Resource economics criteria (e.g., direct costs such as salaries, indirect costs such as overhead, remuneration multiplier [overall remuneration to resource for account divided by total salary costs of personnel on account], and profit/loss ratio) for a user's account may be reported by the resource using different reporting methodologies. Therefore, the invention provides thattthe resource report its overall direct costs, indirect costs, and profit/loss in conformance with the expert methodology and definitions (framework), so variances can be ascertained and taken into account by the expert system. Alternatively, if any of the resource data is provided not within the form of the framework is conformed (“translated”) to fit the framework. The expert or user can ascertain whether incorrect or inconsistent allocations of resources or costs are being applied to the user's account, thereby enabling the user's account to be examined comparably from period-to-period. This additionally allows the user's account to be considered in the context of industry benchmark.

A critical aspect of the invention is to provide the resource and/or user qualitative and quantitative information in a form comparable to corresponding benchmarks and best practices to allow a meaningful comparison to be made. Therefore some instances, it is also necessary for the resource to adapt its internal time reporting and cost accounting system in order to conform to expert methodology and definitions provided to the resource so that, for each criteria evaluated, the resource data/information and benchmark, best practice, best-in-class or other comparison value/information for that criteria are in a form which results in a meaningful comparison which evaluates the business resource. The expert methodology and definitions form an information framework according to the invention.

Hence, the resource's response to the questionnaire is usually in the form of a structured reporting format, i.e., within the framework, but there may also be answers to qualitative questions set forth in the questionnaire or determined during diagnostic interviews that do not readily fit into the framework. Accordingly, data and information deemed important which cannot be conformed to the predetermined reporting criteria and format of the expert system (framework), can according to the system, be recorded and carried through the evaluation process for consideration. Once the quantitative data submitted via the questionnaire is conformed to the expert methodology and definitions, the expert system may proceed with a number of assessments which may or may not be independent of each other. For example, a first type of assessment that can be performed according to the invention is a resource remuneration assessment. and a second type of assessment that can performed is a billed (reimbursed) costs assessment. Each assessment may proceed independent of the other.

In the resource remuneration assessment, a number of elements are considered. These include the user's scope of work (also referred to as “activity,” “deliverables,” or “assignment”) that the resource does for the user in providing its business services. Generally, each scope of work done by a resource for a specific user is unique although there may be common elements between users (e.g., deliverables, staffing level, time and salaries, overhead, and profit/loss) which contribute to an overall understanding of, and allow benchmarking and best practices assessments of users and the related costs to a user. This can be done for each period, usually in six and twelve month increments, and usually over multiple years.

Once data and information are received regarding resource staffing levels and economics, it can be compared and conformed to an expert resource economics model. The outputs from this can be related to other steps in the resource compensation assessment process and related to the outputs from expert diagnostic interviews. This is an aid in refining the expert system as it approaches and concludes in the comprehensive assessment phase. The resource economics model can utilize actual data from the user in the context of benchmarking and other industry data.

The scope of work, e.g., the resource's activity and deliverables on behalf of client's account, is analyzed by the expert comparing it to scopes of work for comparable clients. This can be accomplished through an expert qualitative review process and through an expert quantitative process whereby the scope of work is broken down into deliverables and other discrete units of work production.

Another objective of the resource remuneration assessment is to ascertain the time and nature of each person (resource employee or independent contractor) working on (a) the user's account, (b) other client's accounts and (c) and resource non-client (e.g., administrative) time. In a preferred embodiment of the invention, this is actual time (vs. “standard” cost accounting time).—This provides a more accurate measure of the work performed by the resource on behalf of its client(s) and more reliable comparative analysis of the direct costs.

Once the nature (e.g., title, position, level of seniority) and time of each person (resource employee or independent contractor) working on (a) the user's account, (b) other client's accounts and (c) and resource non-client (e.g., administrative time) is ascertained, these can be correlated to the resource's staffing plan and time records (registers) using expert-defined job specifications. This allows for economic relationships to be determined between the user's scope of work and resource staffing. In another embodiment of the invention, the client's scope of work for the resource and the resource's staffing plan are evaluated with respect to benchmark data and best-practice information efficiency and productivity are correlated to the to variances from the benchmarks and best practices

Information and data obtained from the resource can be conformed to a framework and then compared to corresponding bench data and best practice information. The resource staffing model can take numerous forms, depending on the nature of the resource being examined (advertising agency, law firm, accounting firm, management consultancy firm or other providers of business or professional services). The benchmarks and best practices associated with staffing, collectively form an expert staffing model which is for comparison with the resource staffing plan to evaluate the correctness and efficiency of the resource's staffing plan for the scope of work provided to the user.

Next, the expert system can analyze resource productivity which involves base salary analysis (or, for example, total remuneration analysis including benefits, bonus, etc.), job position analysis, and overhead component analysis. The annual salary of each person working on the user's account is can be used in this analysis. This information can be ascertained either directly (e.g., in a resource questionnaire response) or indirectly (e.g., survey or expert benchmarking). Under this expert system it is preferable to have the resource report individual base salary and time per the resource's payroll registers and time keeping registers. An alternative is to have direct costs per resource department reported in conformance with the expert methodology and definitions. Another alternative expert system can be used whereby resource salaries can be determined using expert benchmarking databases, in which each person working on the user's account is coded to an expert determined position specification. Other alternatives exist as well. A benefit of this expert system is that it can be used for any type of business or professional services.

Overhead components are also reported according to the expert methodology and definitions. The components are then analyzed and benchmarked as a percentage of total indirect costs and with respect to each other.

Resource staffing levels, staffing functions, and staffing salaries may be benchmarked to data obtained for resources of comparable size, type and location to the user's resource. Benchmark data may be obtained from and be proprietary to a knowledgeable expert.

In addition, or alternatively, benchmark data can be obtained through expert surveys, other expert assignments, and third-party data that is conformed to the expert methodology and definitions. The benchmarking data may be recorded in electronic or hard-copy data files. In one embodiment of the invention, the benchmark data is maintained in computer-accessible memory. In addition to indices of comparable resources, the subsets of direct costs, the components of indirect costs, and levels of profit/loss may be compared to each other as ratios and to benchmark data. This may result in variances between resource data and benchmark data. These are retained for further consideration later in the comprehensive assessment phase. Generally, it is the purpose of benchmarking data to give the expert an indication of how close or far the resource data is from a predetermined value, practice or structure, for example, how far from “average” or “best practice.” This information enables the expert system to identify variances in the resource staffing plan and resource economics which allow the determination of correct staffing plan and compensation payable to the resource, from the user's perspective.

A resource generally incurs costs on behalf of the user which are billed to (“passed through” or “reimbursed by”) the user. In ordinary practice, such reimbursement may be done at net or at a markup or commission payable by the user to the resource. For example, for an advertising agency such billed costs may be charges for advertising media placed, production costs of TV commercials, research, travel, and the like. Such amounts may be billed by the resource for user reimbursement or alternatively may be billed to the user by a third-party, for example, the media. For example, an advertising agency is remunerated for services provided to the user, often by a fee on a commission or media spending and the user may additionally pay the costs for advertising created by the agency for the user. This is a “billed cost.” Other billed costs may also be incurred by the agency which are billed to the client in addition to the agency's remuneration paid by the user, for example, production, expert research, and travel costs.

Billed costs can be indexed to benchmark data of comparable costs. This, as with other benchmarking data, can be proprietary to a knowledgeable expert and/or obtained through expert surveys, other expert assignments or third party data conformed to the expert methodology and definitions provided by the invention. This data/information can be maintained in electronic and hardcopy data files. In one embodiment of the invention, this data/information is recorded in computer accessible memory. The subsets of billed costs may be compared to each other as ratios and to benchmark data. This may result in variances between resource data and benchmark data. These are retained for further consideration at the assessment stage. Generally, it is the purpose of benchmarking data to give, by comparison to data/information of the resource, an indication of how close or far the resource data is from “average” or “best” values or from “best practice.” For example, such billed costs in the advertising services area include but are not limited to payments for media time and TV production costs. As a further example, billed costs in the legal services area include but are not limited to the cost of photocopying, and remuneration paid top private investigative agencies and expert witnesses.

All of the foregoing aspects deriving from the expert questionnaire and the expert diagnostic interviews process, together with the various benchmarking analyses, index/ratio analyses, and variance reports, flow through to and are considered together at the comprehensive assessment phase. At this stage material quantitative and qualitative variances can be considered and related to one another. Each variance can optionally be weighted depending on a knowledgeable expert's decision or assignment as to which ones are more important to the user in the situation, according to the methods known in the art. These weightings can also be stored in computer accessible memory, thereby enabling computerized systems according to the invention to retrieve and apply the weightings in the evaluation process.

The invention also provides that adjustments or corrections to the reported resource data and information can be made by a knowledgeable expert.

Criteria Internal to the User that are Related to Use of the Resource

It is understood that, according to the invention, certain data and information such as scope of work and amount of compensation paid out to the business resource by the user is also, or only, obtainable from the user and thus questionnaires and/or diagnostic interviews according to the invention may also be directed to the user. For example, this is particularly the case when an aim of the assessment is to also evaluate the user's own resource-management procedures in connection with the evaluating the efficiency of the user-business resource relationship. Such “internal” criteria, which is obtainable form the user, may also be compared to benchmarks and/or best-practices in order to generate evaluations and recommendations for optimizing the productivity and efficiency of the user's use of the resource, in connection with the user's own operating procedures and policies. Examples of internal criteria include, but are not limited to, the numbers and nature/seniority level of person(s) assigned to originate and/or manage use of resource, the approval process for originating and managing use of the resource, and the time spent in originating and managing use of resource.

The invention further provides for creating optimum pro-forma scenarios of resource staffing and resource remuneration. Thus, the assessment/evaluation may then be best presented and matched with the user's objectives and goals in causing the assessment. Accordingly, various optimization scenarios are created by using previous conformation data and variances from the questionnaire and diagnostics. These can then arranged as alternative value-for-money (cost-effectiveness), price-per-value (price/value), and optimization scenarios in providing an expert opinion report and recommendations to the user.

The expert report and recommendations flowing from this evaluation method can emulate the considered opinion-forming process and opinion of one or more knowledgeable experts on the extent to which the resource's actual or proposed base remuneration, incentive remuneration, billed costs, and/or organization structure and process that meet benchmark, “best practices,” and/or the user's objectives. This can be presented by the expert system in both quantitative (e.g., financial benefit) terms and in qualitative (e.g., relationship and process improvement) terms in the report.

Upon consideration of the expert report and recommendations, the user may implement a recommendation and/or proceed to “next steps” necessary to implement a recommendation.

Since a user's scope of work for its business services resource and the resource's staffing, direct costs, indirect costs, and profit/loss are subject to variances and market conditions, these can change over time from that intended, and it can be important to track and benchmark the user's account with its resource. This is intended to keep the metrics agreed to by the user with its resource consistent with the user's resource financial and resource relationship objectives. This expert system is also a business management tool, and tracking contributes to the updating and real-time applicability of the system.

The user may periodically cause an audit of the resource's books and records relating to the user's account to make certain that the financial objectives of the user, effectiveness of resource deliverables, and the underlying assumptions for resource remuneration are on track and that the user's resource relationship objectives are achieved.

This expert system provides a dynamic business management tool that can be enhanced and added to over time to increase its benefit to the user and its business services resource.

### EXAMPLE 1

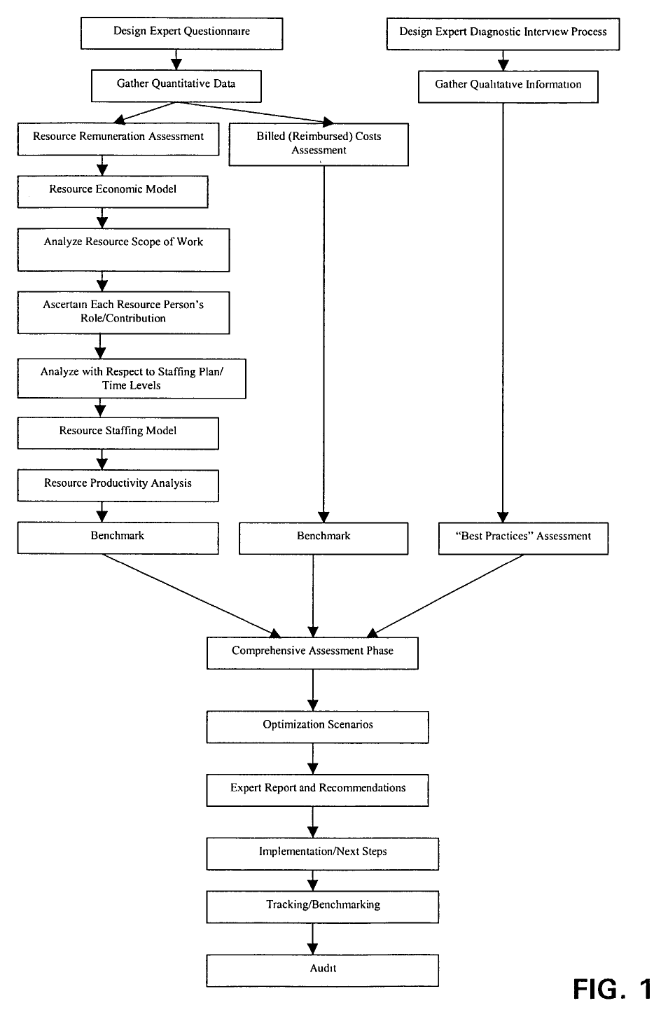

Example 1 illustrates an embodiment of the method of the invention and is shown by the flowchart of FIG. 1.

### EXAMPLE 2

In accordance with one computer implemented embodiment of invention, a system for generating a business services provider productivity and remuneration-correctness assessment includes at least one computer processor, computer accessible memory and computer instructions which direct the at least one computer processor to perform the steps of the method of the-invention. The expert methodology and definitions is also part of the system.

The computer readable memory, in part, takes the form of a database that stores resource data and also survey data and/or benchmark values for each of at least one predetermined quantitative business metric categories. The survey data numerically represents a qualitative assessment concerning metrics associated with a business services provider. It may likewise represent a quantitative assessment concerning the same and other metrics. For example, raw survey data from among several similar business service providers can be obtained via direct survey of each of these comparable resources or obtained in whole or in part from one or more third-party sources. Such survey data may be operated on to generate various sorts of benchmarks for each business metric category. For example, for quantitative data, benchmarks such as the average value, average value +/− standard deviation, average of top-5% best value/performing within category, etc. may be assigned. In addition, or alternatively, benchmark values for a given category can be directly assigned by a knowledgeable expert or as a result of a survey of knowledgeable experts. Qualitative categorical information relating to processes, protocols, practices, policies, organizational structures, etc. can similarly be designated as best-practices/structures (1) by identifying them as such by determining the practice/structure information within the survey data to those sampled providers having the best quantitative results, for example, these having the greatest value-for-money and/or (2) by assignment as such by a knowledgeable expert and/or (3) by identifying them as a result of a survey of knowledgeable experts.

The same or a different database is provided to store data for the business resource(s) to be evaluated. The data for the resource is categorized and conformed in the same fashion as the survey or benchmark data/information, i.e., according to the framework.

The system according to this embodiment of the invention also comprises a retriever, a calculator, a report generator and, optionally, a comparator and relator. These elements comprise computer instructions directing the at least one computer processor to perform the functions of the elements in concert with the computer accessible memory.

Accordingly, a retriever is coupled with the database(s) and retrieves selected resource data and survey data and/or benchmark values from the database.

A calculator is coupled to the retriever and operable to receive the retrieved business metric data and corresponding benchmark data and generate a comparison value between the two.

Optionally, a comparator is coupled to the retriever and is operable to receive the business practice information of the resource and the corresponding best practice or other “structural benchmark” information and generate a determination of relatedness, i.e., the sameness or difference and/or relative sameness or difference between that which is compared.

The report generator is coupled to and receives the out put of each of the calculator and the comparator and generate an “comparative” assessment report. Thus, a business services provider productivity and/or remuneration-correctness assessment by comparing the comparison value to one or more related benchmark values. This, in itself, is a first type of useful report according to the invention.

A relator is optionally coupled to the calculator and comparator and correlates positive (advantageous to the resource's client) or negative (disadvantageous to the resource's client )variances in qualitative business data from the benchmark to other qualitative business data variances and/or qualitative business practices/structure information. In this fashion, the system correlates unfavorable performance of the resource to particular “failing quantitative criteria” (e.g., resource employs too many personnel in particular position causing unnecessarily high costs to resource's client) and/or particular business practice (e.g. a resource's excessive charge to user might be determined to be due to a particular higher than average pass through cost due to the resource's inefficiency in obtaining a best price). A similar correlation can be made with positive variances. These correlations can, for example, be used to generate recommendations for improving the efficiency, productivity and business process of the particular resource provider.

The assessment generated by the system and method of the invention may optionally be stored in computer readable memory and/or printed out in the form of a report and/or other otherwise presented or disseminated according to any known method.

The computerized system described in the preceding example is an example of an “evaluator” according to the invention.

### EXAMPLE 3

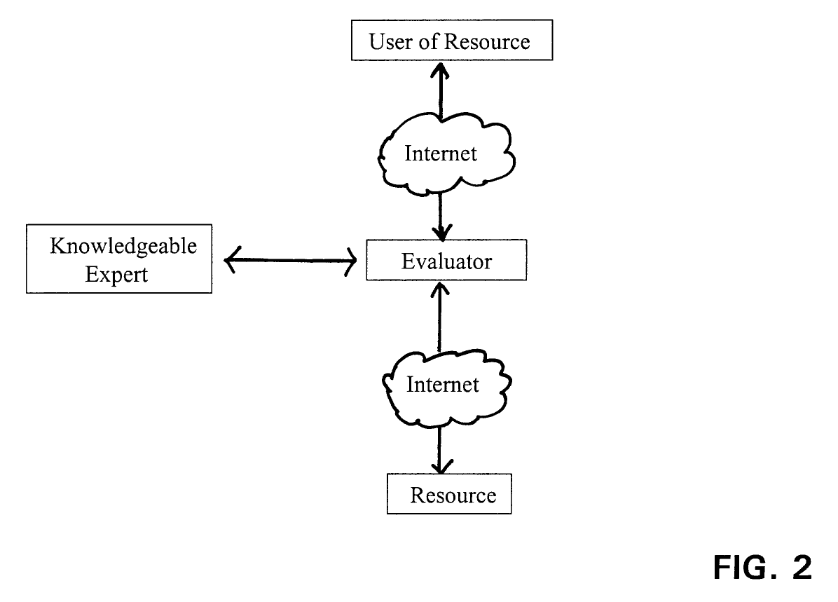

Example 3, which is described with reference to FIG. 2, illustrates an Internet-based embodiment of the invention, wherein, for example, various information is exchanged via the World Wide Web. Accordingly, the embodiment shown in FIG. 2 comprises an evaluator such as the evaluator described in Example 2. However, the evaluator of the present embodiment further comprises Internet connections and at least one web server. Thus, the evaluator serves interactive web pages to the user of the resource which query the user of the resource to provide the user information previously described herein, according to an information reporting framework. Further, the evaluator serves interactive web pages to the resource to query the resource for the resource information previously described herein, according to an information reporting framework. A knowledgeable expert may interact with the evaluator at various stages of the evaluator's performance of the method of the invention. One function that the skilled expert may perform is providing the evaluator with benchmark data and best practice information, which collectively may be referred to herein as an “expert resource model”. Similarly, in embodiments wherein the user's quantitative data and qualitative information is to be evaluated, the skilled expert may provide the evaluator with benchmark data and best practices information, collectively forming an “expert user model.”

Another function that the skilled expert may perform is conforming data and information provided by the resource or user of resource to the framework of expert methodology and definitions when the resource or user of resource have not properly or fully done so. The knowledgeable expert may interact with the evaluator directly or indirectly via the Internet including for example via the World Wide Web or by any fashion.

The user of the resource, or other authorized party, can also be served and receive the report/assessment generated by the evaluator, via the Internet by transfer of files in any acceptable format, including but not limited to, text or image files served via e-mail or ftp or web pages served according to HTTP.

The evaluator is programmable to optionally notify and request updated information from the resource and/or user of resource and perform an updated evaluation, at preset periodic intervals, at preset dates and/or at the request of the user of the resource or other authorized party.

Various aspects of the present invention are shown and described herein with reference to particular embodiments of the invention. Persons skilled in the field will recognize that various changes in form and details of the invention may be made without departing from its spirit and scope. Accordingly, the scope of the invention is to be determined solely in connection with the appended claims and their equivalents.

1. A computerized expert system for evaluating the business metrics of a service provider, comprising:
at least one computer processor;
computer accessible memory;
a framework for reporting selected service business metrics data and practices information;
at least one database operable to store the business metrics data and practices information of a business services resource according to the framework and benchmark data and/or best practice information according to the framework;
a retriever coupled to the database and operable to retrieve from the database selected business metrics data of the resource and corresponding benchmark data and/or selected business practice information of the resource and corresponding best practices information;
a calculator coupled to the retriever and operable to receive the retrieved business metric data and corresponding benchmark data and generate a comparison value between the business metric and benchmark data; and
a comparator coupled to the retriever and able to receive the business practice information of the resource and the corresponding best practice information and generate a determination of relatedness.

2. The system according to claim 1, further comprising a relator coupled to the calculator and comparator which correlates selected comparison values to other comparison values and/or to relatedness between practice information of the resource and the corresponding best practice information.

3. The system according to claim 1 or 2, further comprising a report generator.

4. The system according to claim 1 or 2, further comprising a web server operably linking the system to a computer network.

5. The system according to claim 3, further comprising a web server operably linking the system to a computer network.

6. A computer-implemented method for evaluating a service provider in a preselected service area, comprising the steps of:
providing quantitative benchmark business metric data for the service area, wherein the data is categorized by preselected quantitative criteria in computer-readable memory;
providing quantitative business metric data for the service provider wherein the data is categorized by preselected criteria in computer-readable memory;
for at least one of the preselected criteria, generating a comparison value between the benchmark business metric data and the service provider business metric data; and
generating a business metric evaluation report/assessment according to the comparison.

7. The method according to claim 6, further comprising the steps of:
providing, in computer-readable memory, qualitative best practice or best-in-class assignment information for the service area, wherein the best practice or best-in-class assignment data is categorized by preselected qualitative criteria;
providing, in computer-readable memory, qualitative information for the service provider categorized according to the preselected qualitative criteria;
for at least one of the preselected qualitative criteria, comparing the best practice or best-in-class assignment to the information for the service provider to determine for that criterion whether the productivity, economics and other business metric data of the service provider provides value to the user for the remuneration paid by the user to the service provider.

8. The method according to claim 7, further comprising the step of:
relating the qualitative criteria differences between best practice or best-in-class and service provider qualitative information to differences between the quantitative benchmark business metric data and/or service provider business metric data.

9. The method according to claim 6 or 7, wherein the at least one of the preselected criteria is selected from the group consisting of direct costs, indirect costs, remuneration multiplier, and profit/loss.

10. The method according to claim 7, wherein at least one of the qualitative criteria is selected from the group consisting of staffing plan structure, organizational structure, and business practices of the provider.

11. The method according to claim 6 or 7, wherein the step of generating a business metric evaluation report/assessment according to the comparison comprises correlating the scope of work that the service provider performs for the user to the service provider's staffing (resource) plan for the user for that scope of work.

12. The method according to claim 6 or 7, wherein the step of generating a business metric evaluation report/assessment according to the comparison comprises correlating the business metric data of the service provider's staffing plan for the user's scope of work to corresponding benchmark business metric data.

13. The method according to claim 6 or 7, wherein the step of generating a business metric evaluation report/assessment according to the comparison comprises correlating the user's scope of work to the service provider's staffing plan.

14. The method of claim according to claim 6 or 7, wherein the step of generating a business metric evaluation report/assessment according to the comparison comprises performing simulations to determine the productivity and economics applicable to a specific user situation at a business service provider using input databases comprising a work project metrics database, a methodology and definitions database, a staffing (resource) metrics database, and a benchmark business metrics database.

15. The method of claim according to claim 6 or 7, wherein the step of generating a business metric evaluation report/assessment according to the comparison comprises performing simulations to calculate the productivity and economics applicable to a specific user situation at a business service provider whereby input databases comprising a work project metrics database, a methodology and definitions database, a staffing (resource) metrics database, and a benchmark business metrics database are used.

16. The method according to claim 6 or 7, wherein:
the business service area comprises advertising services and the business metrics are associated with advertising;
the business service area comprises marketing communications services and the business metrics are associated with marketing services;
the business service area comprises legal services and the business metrics are associated with legal services;
the business service area comprises consulting services and the business metrics are associated with consulting services
the business service area comprises accounting services and the business metrics are associated with accounting services;
the business service area comprises financial services and the business metrics are associated with financial services;
the business service area comprises engineering services and the business metrics are associated with engineering services;
the business service area comprises architectural services and the business metrics are associated with architectural services; or
the business service area comprises information or technology services and the business metrics are associated with information or technology services.

17. A method for evaluating a service provider in a preselected service area, comprising the steps of:
providing quantitative benchmark business metric data for service providers in the service area, wherein the data is categorized by preselected quantitative evaluation criteria;
providing quantitative business metric data for the service provider wherein the data is categorized by the preselected quantitative criteria; for at least one of the preselected criteria, generating a comparison value between the benchmark business metric data and the service provider business metric data; and
generating a service provider business metric evaluation report/assessment according to the comparison.

18. A method for evaluating a service provider in a preselected service area, comprising the steps of:
providing quantitative benchmark business metric data for service providers in the service area, wherein the data is categorized by preselected quantitative criteria;
providing quantitative business metric data for the service provider wherein the data is categorized by the preselected quantitative criteria;
for at least one of the preselected criteria, generating a comparison value between the benchmark business metric data and the service provider business metric data;
providing qualitative best practice information for the service providers in the service area, wherein the best practice information is categorized by preselected qualitative evaluation criteria;
providing qualitative business practice information for the service provider categorized according to the preselected qualitative criteria;
for at least one of the preselected qualitative criteria, comparing the best practice information to the business practice for the service provider to determine the relatedness between the business practice and best practice information; and
generating a service provider evaluation report/assessment according to the comparison and the determination of relatedness.

19. A method for evaluating a service provider usage in a preselected service area, comprising the steps of:
providing quantitative benchmark business metric data for service providers in the service area, wherein the data is categorized by preselected provider quantitative evaluation criteria;
providing quantitative business metric data for the service provider wherein the data is categorized by the preselected provider quantitative criteria;
for at least one of the preselected provider quantitative criteria, generating a comparison value between the benchmark business metric data and the service provider business metric data;
providing qualitative best practice assignment information for service providers in the service area, wherein the best practice information is categorized by preselected qualitative evaluation criteria;
providing qualitative business practice information for the service provider categorized according to the preselected provider qualitative criteria;
for at least one of the preselected provider qualitative criteria, comparing the provider best practice information to the business practice information for the service provider to determine the relatedness between the provider best practice information and the provider business practice information;
providing qualitative user best practice assignment information for users of service providers in the service area, wherein the best practice information is categorized by preselected user qualitative criteria relating to the use of service providers in the service area;
providing qualitative user business practice information for the user of the service provider categorized according to the preselected user qualitative evaluation criteria;
for at least one of the preselected user qualitative criteria, comparing the user best practice information to the user business practice information to determine the relatedness between the user best practice and the user business practice information; and
generating a service provider services productivity and efficiency evaluation report/assessment according to the comparisons and the determinations of relatedness.

20. The method according to claim 19, further comprising the steps of:
providing quantitative user benchmark data for users of service providers in the service area, wherein the user benchmark data is categorized by preselected user quantitative evaluation criteria relating to the use of service providers in the service area;
providing quantitative data for the user of the service provider categorized according to the preselected user quantitative criteria; and
for at least one of the preselected user quantitative criteria, generating a comparison value between the user benchmark information and the user quantitative data.

21. A method for evaluating the correctness of usage by user of a service provider in a preselected service area comprising the steps of:
providing quantitative user benchmark data for users of service providers in the service area, wherein the user benchmark data is categorized by preselected user quantitative evaluation criteria relating to the use of service providers in the service area;
providing quantitative data for the user of the service provider categorized according to the preselected user quantitative criteria; and
for at least one of the preselected user quantitative criteria, generating a comparison value between the user benchmark information and the user quantitative data; and
generating a service provider usage evaluation/assessment according to the comparison value.

22. The method according to claim 21, further comprising the steps of:
providing qualitative user best practice assignment information for users of service providers in the service area, wherein the best practice information is categorized by preselected user qualitative evaluation criteria relating to the use of service providers in the service area;
providing qualitative user business practice information for the user of the service provider categorized according to the preselected user qualitative criteria;
for at least one of the preselected user qualitative criteria, comparing the user best practice information to the user business practice information to determine the relatedness between the user best practice and the user business practice information,
wherein the step of generating a service provider usage evaluation/assessment further comprises generating the evaluation/assessment according to the determination of relatedness.
